(19) United States
(12) Patent Application Publication
(10) Pub. No.: US 2016/0083259 A1
(43) Pub. Date: Mar. 24, 2016

(54) REDUCTANT STORAGE

(71) Applicants: George D. BOYD, (US); Ramon A. MELLA, (US); John E. RYAN, Carmel, IL (US); INTERNATIONAL ENGINE INTELLECTUAL PROPERTY COMPANY, LLC, Lisle, IL (US)

(72) Inventors: George D. Boyd, New Palestine, IN (US); Ramon A. Mella, Maple Park, IL (US); John E. Ryan, Carmel, IN (US)

(73) Assignee: International Engine Intellectual Property Company, LLC, Lisle, IL (US)

(21) Appl. No.: 14/786,403

(22) PCT Filed: Apr. 22, 2013
(86) PCT No.: PCT/US13/37529

§ 371 Date: Oct. 22, 2015

(51) Int. Cl. C01C 1/00; B01D 53/56; F01N 3/20

(52) U.S. Cl. CPC C01C 1/006; F01N 3/2066; B01D 53/56; F01N 2610/02; F01N 2610/1406

(57) ABSTRACT

An assembly and method for storing a reductant, including ammonia, for use in the treatment of NOₓ in an exhaust stream, is disclosed. The assembly comprises a cartridge having an interior space, a disk formed from compacted reductant adsorbing/desorbing material contained within a heat transfer material, and, an expandable element positioned within the interior space of the cartridge for receiving a plurality of disks within the interior space of the cartridge. The expandable element or conduit may also be used to charge or recharge the adsorbing/desorbing material with ammonia.

### TECHNICAL FIELD

The present device and method relate to the storage and delivery of a reductant, such as ammonia. Particularly, the device and method relate to storage of a reductant within an adsorbing/desorbing material as a disk within a cartridge for use in the reduction of NOₓ in an exhaust stream.

### BACKGROUND

Compression ignition engines provide advantages in fuel economy, but produce both NOₓ and particulates during normal operation. New and existing regulations continually challenge manufacturers to achieve good fuel economy and reduce the particulates and NOₓ emissions. Lean-burn engines achieve the fuel economy objective, but the high concentrations of oxygen in the exhaust of these engines yields significantly high concentrations of NOₓ as well. Accordingly, the use of NOₓ reducing exhaust treatment schemes is being employed in a growing number of systems.

One such system is the direct addition of a reductant, such as ammonia gas to the exhaust stream. It is an advantage to deliver ammonia directly in the form of a gas, both for simplicity of the flow control system and for efficient mixing of reducing agent, ammonia, with the exhaust gas. The direct use of ammonia also eliminates potential difficulties related to blocking of the dosing system, which are cause by precipitation or impurities, e.g., in a liquid-based urea solution. In addition, an aqueous urea solution cannot be dosed at a low engine load since the temperature of the exhaust line would be too low for complete conversion of urea to ammonia and CO₂.

Transporting ammonia as a pressurized liquid, can be hazardous if the container bursts due to an accident or if a valve or tube breaks, yet would be a cost effective solution if a fail-proof design is achieved. For the moment, using a solid storage medium offers an additional safety margin since a small amount of heat is required to release the ammonia and the equilibrium pressure at room temperature can be—if a proper solid material is chosen—well below 1 bar. Previous designs for delivery of solid ammonia, such as ammonia saturated strontium chloride, included wrapping the material into aluminum foil balls. The balls are then placed in a canister where they are pressed under a load of up to 300 tons to reach a density of approximately 1.2 g/cc. However, the machines typically required to fill and wrap the foil balls needs to be at very high speed (6 parts per second) in order to achieve the necessary rate for high volume. In addition, such machines tend to be expensive and difficult to maintain. Finally, it can be difficult to load the balls into the machine without damaging them, in that the wrapping can become unsealed, loose and subject to leakage. Therefore, conveying the foil balls at the speed required to meet the desired volume would likely be difficult to do without damaging them.

Handling of material containing ammonia may be hazardous, as equipment should be designed to be well ventilated or able to capture vapors. Thus, the present device and method relate to compressed disks composed from a non-saturated (without reductant) solid adsorbing/desorbing material, which can then be charged with reductant, such as ammonia, after assembly as disks into a cartridge. In order to release the ammonia gas from its adsorptive or absorptive solid storage material, sufficient heat needs to be applied. In addition, the heat transfer needs to be efficient enough to reach the solid storage material through the containers or cartridge holding the material. The present device and method also provide for sufficient heat transfer between the heat conductive material by fracturing the adsorbing/desorbing material disks, exposing additional surface area and enhancing heat conduction required for release of ammonia for use in the reduction of NOₓ in an exhaust stream.

### SUMMARY

An assembly for storing a reductant, including ammonia, for use in the reduction of NOₓ in an exhaust stream, is disclosed. The assembly is useful in storing and transporting ammonia, as well as, providing sufficient heat transfer to the adsorbing/desorbing material for effective release of ammonia into the exhaust stream.

In an embodiment, an assembly for storing a reductant for use in the treatment of NOₓ in an exhaust stream, is disclosed. The assembly comprises a cartridge having an interior space, a disk formed from compacted adsorbing/desorbing material contained within a heat transfer material, and, an expandable element positioned within the interior space of the cartridge for receiving a plurality of disks within the interior space of the cartridge.

In another embodiment, the expandable element comprises a tube having a plurality of openings along its length permitting the flow of ammonia for charging and recharging the adsorbing/desorbing material with ammonia.

In yet another embodiment, the tube further includes an outer diameter adapted for expanding within the stacked plurality of disks and fracturing the disks.

In another embodiment, the assembly for storing a reductant comprises a cartridge having an interior space and sidewalls, a plurality of nestable disks comprising a heat conductive material forming a cup for receiving a compacted adsorbing/desorbing material layer, each disk having a opening there through, a conduit positioned within a length of the interior space of the cartridge and adapted for receiving the plurality of nestable disks through each opening, and, wherein the plurality of nestable disks are inserted into the cartridge onto the conduit in alternating layers of the heat conductive material and the adsorbing/desorbing material so that the heat transfer material is in contact with the sidewalls of the cartridge.

A method for storage and delivery of ammonia as a reductant, is disclosed. The method comprises the steps of providing a cartridge having sidewalls, providing a plurality of nestable disks comprising a heat conductive material forming a cup for receiving an ammonia adsorbing/desorbing material layer, each disk having a opening there through, positioning a conduit having an outer diameter within a length of the interior space of the cartridge, stacking the plurality of disks onto the conduit in alternating layers of heat conductive material and adsorbing/desorbing material, expanding the outer diameter of the conduit within the plurality of disks fracturing the ammonia adsorbing/desorbing material, contacting the adsorbing/desorbing material and heat conductive layer with the sidewalls of the cartridge, applying heat from a heat source to the cartridge, the fractured adsorbing/desorbing material, and the heat conductive layer, and, releasing ammonia from the adsorbing/desorbing material into an exhaust system for use in the reduction of NOₓ.

These and other aspects of the present assembly and method may be understood more readily from the following description and the appended drawings.

### BRIEF DESCRIPTION OF THE DRAWINGS

FIG. 1 is a perspective view of the assembly for storing and charging and/or recharging the reductant adsorbing/desorbing material;

FIG. 2 is a perspective view of the disk useful in the present assembly;

FIG. 2a is a side view of the disk shown in FIG. 2;

FIG. 3 is perspective view of the expandable element or conduit having a plurality of disks as used in the present assembly.

### DETAILED DESCRIPTION

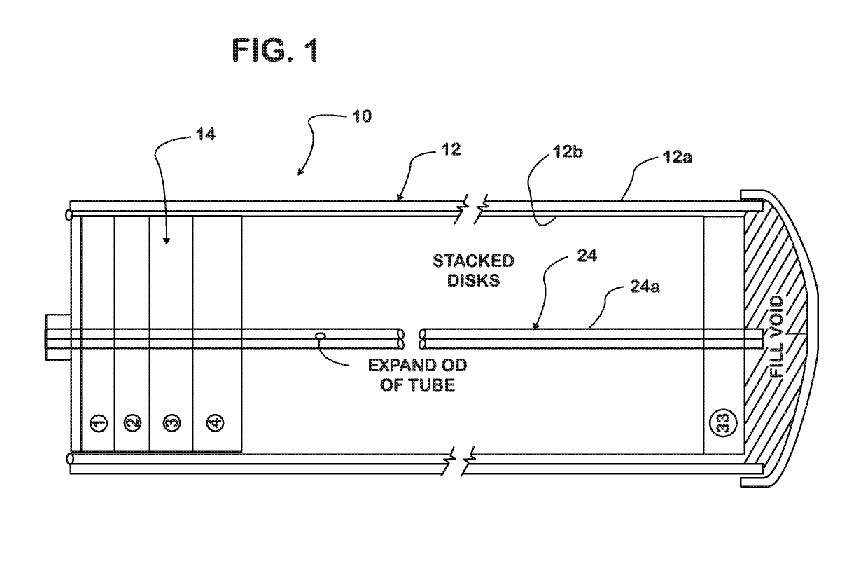

Referring to FIGS. 1-3, there is illustrated an assembly and method for storage of a solid form material, and delivery of reductant, including ammonia gas, for use in an exhaust gas NO reduction (EGNR) system of an internal combustion engine. The present assembly, generally designated by the numeral 10, is discussed with respect to ammonia storage and delivery, specifically for supplying ammonia gas to a compression ignition engine, as well as, a device for initially charging the ammonia adsorbing/desorbing material, and recharging the material once it has released its ammonia gas. Ammonia gas is useful in the exhaust system (not shown) of a vehicle for the reduction of NO_{R}. As the exhaust system of a vehicle, including that of a diesel engine, is well known, it will not be described in detail.

As shown in FIG. 1, in the storage and transport assembly 10, a cartridge 12 is used for storing disks 14 containing reductant adsorbing/desorbing material 16. The cartridge 12, also known as a container or canister, can have any suitable shape, but is typically a cylindrical shape with an exterior 12a and an interior 12b. The cartridge 12 is sealable at both ends using standard sealing techniques after loading the disks 14. The cartridge 12 can be constructed from any suitable material that is sturdy for loading and transporting the material. In addition, the material for constructing the cartridge 12 should ideally conduct heat, because the adsorbing/desorbing material contained within a disk 14 as used in the present assembly and method, requires heat to desorb ammonia gas from the material. Aluminum sheets are a suitable material for use in constructing the cartridge 12 in a known manner. Aluminum has a low mass density and excellent thermal conductivity.

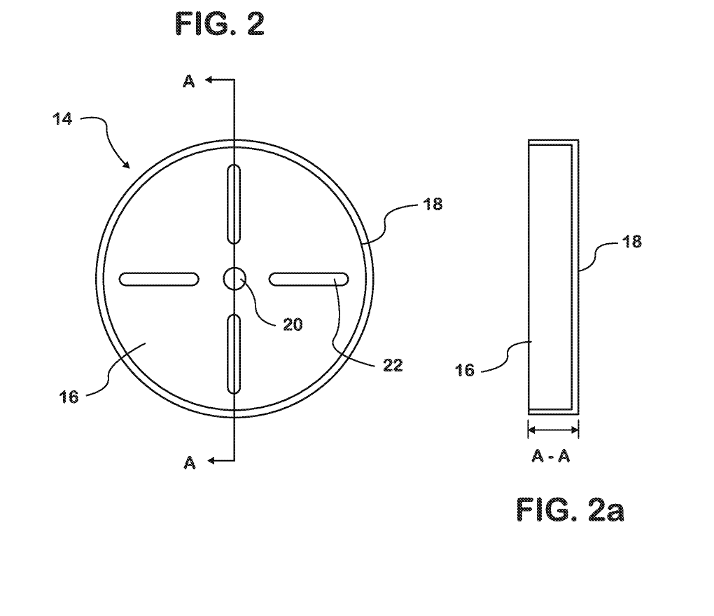

As shown in FIG. 2, the adsorbing/desorbing material is formed into disks 14 using standard powdered metal press technology. The disks 14 comprise adsorbing/desorbing material 16 compacted into a heat conductive material liner 18 having a cup shape, at a thickness of about ¾ inches and about an 8 inch diameter. The length of the cartridge and final compaction rate will determine actual thickness. The size of the disk 14 makes it convenient for loading into the cartridge 12, and allows for expansion of the disk material within the cartridge after charging the material with ammonia. Each disk 14 includes an opening 20 passing there through. It should be understood that while a disk 14 containing adsorbing/desorbing material is shown, the material can have any suitable form, including as compressed granules or a tight-packed powder. In addition, the material, particularly in a granular form, may have sheets or pieces of metal dispersed throughout the material, which increases the thermal conductivity of the material. Regardless of the technology used to prepare the material, and load it into the canister for use, it is important to prevent the dissipation of reductant during the formation of the material. Alternatively, a non-saturated (without ammonia) material may be used to form the disk, thus avoid any potential handling issues and the requirement for specialized ventilation equipment.

Suitable reductant adsorbing/desorbing material 16 for use in the present assembly 10 include metal-ammine salts, which offer a solid storage medium for ammonia, and represent a safe, practical and compact option for storage and transportation of ammonia. Ammonia may be released from the metal ammine salt by heating the salt to temperatures in the range from 10° C. to the melting point to the metal ammine salt complex, for example, to a temperature from 30° to 700° C., and preferably to a temperature of from 100° to 500° C. Generally speaking, metal ammine salts useful in the present device include the general formula M(NH₃)ₙX_{z}, where M is one or more metal ions capable of binding ammonia, such as Li, Mg, Ca, Sr, V, Cr, Mn, Fe, Co, Ni, Cu, Zn, etc., n is the coordination number usually 2-12, and X is one or more anions, depending on the valence of M, where representative examples of X are F, Cl, Br, I, SO₄, MoO₄, PO₄, etc. Ammonia saturated strontium chloride, Sr(NH₃)Cl₂, may be used in creating the disk 14 of the present assembly 10. Alternatively, a non-saturated strontium chloride may be used, and after the disk is formed and loaded into the cartridge, the strontium chloride disk is charged with ammonia using a conduit 24 as will be described. While embodiments using ammonia as the reductant are disclosed, the present disclosure is not limited to such embodiments, and other reductants may be utilized instead of, or in addition to, ammonia for carrying out the system and method disclosed and claimed herein. Examples of such other, or additional reductants include, but are not limited to, urea, and ammonium carbamate.

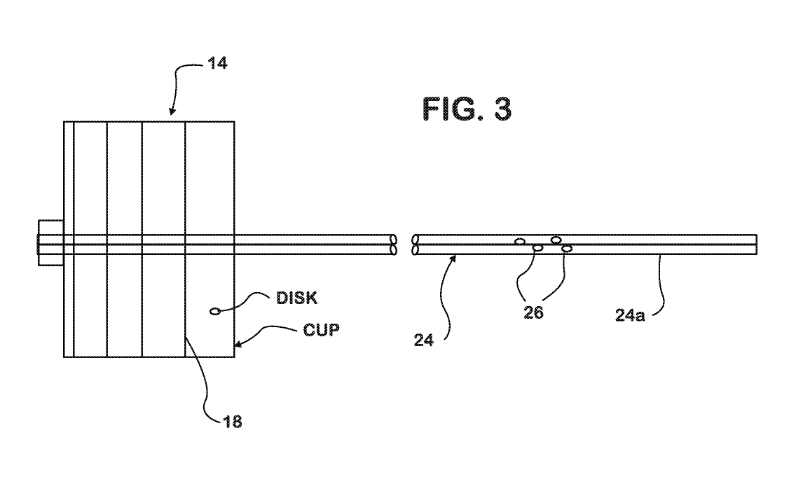

As shown in FIG. 3, in order to facilitate loading of the disks 14 into the cartridge 12, an expandable element or conduit 24, is provide. The expandable element or conduit 24 typically has a tube or rod shape, which can be either straight or curved, and is constructed from a light-weight heat conductive material, such as aluminum. The expandable element 24 is positioned generally within the length of the interior space of the cartridge 12 in order to facilitate loading as many disks 14 within the cartridge as possible. By expandable, it is meant that the diameter of the tube or rod can increase and expand outwardly.

Each disk 14 is stacked through its opening 20 onto the expandable element 14 in an alternating manner, resulting in the adsorbing/desorbing material 16 being layered between the heat conductive or heat transfer material 18. Additionally, each disk 14 includes at least one fracture line 22, to facilitate the breaking of the disk as will be described. The disks 14 are nestable onto one another, which provides improved contact between the adsorbing/desorbing material of the disks with the heat conductive or transfer layer of the adjoin disk.

The expandable element or conduit 24 may serve several functions depending on the requirements of a particular system. For example, if the disks 14 are initially composed of non-saturated reductant adsorbing/desorbing material 16, the conduit may include a plurality of holes 26 (FIG. 3) along its length. Ammonia gas can then be fed into the conduit 24 and through the holes, where it charges the non-saturated ammonia adsorbing/desorbing material with ammonia. After the ammonia gas is released from the material 16 during use in the NOx reduction system, the conduit 24 can be used to re-charge the material with fresh ammonia gas for the next use. Charging the ammonia adsorbing/desorbing material after loading the disks into the cartridge and sealing the cartridge eliminates the need to pre-mix the material with ammonia, as well as avoids the requirement for special ventilation equipment related to the handling of ammonia-containing material. Furthermore, charging the disks 14 after loading into the cartridge expands the disks creating improved surface contact between the heat transfer material 18 and the disk material 16, improving heat transfer to the material required for release of the ammonia.

Another function of the expandable element 24 would be to provide a means for breaking or fracturing the adsorbing/desorbing material 16 contained within the heat transfer material layers 18. As previously noted, in order to use the ammonia as a reductant in, for example, the treatment of NOₓ in a vehicle exhaust system, it is necessary to apply a sufficient amount of heat to the cartridge 12 and the disks 14, and in particular, to the ammonia adsorbing/desorbing material 16 and the heat transfer layer 18, to effectively release the ammonia gas. Thus, in order to achieve an effective amount of heat transfer to all of the materials, sufficient contact of the materials with one another is desired. The expandable element 24, which has an expandable outer diameter 24a, works to effectively expand and fracture the disks 14, exposing more surface area between the adsorbing/desorbing material 16, the heat transfer layer 18 and the interior walls of the cartridge 12. In this manner, heat transfer is more effective. Expanding the outer diameter 24a of the expandable element 24 may be achieved through insertion of a mechanical widening device, such as a ball-shaped mandrel inserted through the length of the tube, or through flow of a high pressure gas through the element.

The present assembly 10 is useful in a method for storage and delivery of a reductant, including ammonia for use in NO reduction system. The method includes providing a plurality of nestable disks 14 comprising a heat conductive material 18 forming a cup for receiving an adsorbing/desorbing material layer 16. The adsorbing/desorbing material can be either non-saturated (without ammonia) or ammonia-containing when formed as a disk. A conduit 24 is positioned within a length of the interior space 12a of the cartridge. The conduit includes an expandable diameter and a plurality of holes along its length to encourage the flow of ammonia into the adsorbing/desorbing material. A plurality of disks 14 are stacked onto the length of the conduit 24 in alternating layers of heat conductive material and ammonia adsorbing/desorbing material. The outer diameter 24a of the conduit 24 may be expanded either mechanically or through the high pressure flow of a gas. As the outer diameter expands, the ammonia adsorbing/desorbing material within the disks 14 fractures, thereby contacting the ammonia adsorbing/desorbing material 16 and heat conductive layer 18 with the sidewalls of the cartridge 12. Heat from a heating source is applied to the cartridge, the fractured ammonia adsorbing/desorbing material 16, and the heat conductive layer 18, releasing ammonia from the ammonia adsorbing/desorbing material into an exhaust system for use in the reduction of NOₓ.

What is claimed is:

1. A reductant storage assembly for use in treatment of NOₓ in an exhaust stream, the assembly comprising:
a cartridge having an interior space;
a disk formed from a compacted adsorbing/desorbing material contained within a heat transfer material; and,
an expandable element positioned within the interior space of the cartridge for receiving a plurality of disks within the interior space of the cartridge.

2. The assembly of claim 1, wherein each disk further includes an opening passing through the disk.

3. The assembly of claim 2, wherein the expandable element passes through the openings of each disks nesting a plurality of disks within the interior space of the cartridge.

4. The assembly of claim 3, wherein the plurality of nesting disks further comprise alternating layers of the heat transfer material and the adsorbing/desorbing material.

5. The assembly of claim 1, wherein the expandable element comprises a tube having a plurality of openings along its length permitting the flow of reductant for charging and recharging the adsorbing/desorbing material with reductant.

6. The assembly of claim 5, wherein the reductant is ammonia.

7. The assembly of claim 5, wherein the tube further includes an outer diameter adapted for expanding within the stacked plurality of disks and fracturing the disks.

8. The assembly of claim 1, wherein the adsorbing/desorbing material comprises a metal ammine salt.

9. The assembly of claim 8, wherein the metal-ammine salt comprises non-saturated strontium chloride.

10. A reductant storage assembly comprising:
a cartridge having an interior space and sidewalls;
a plurality of nestable disks comprising a heat conductive material forming a cup for receiving a compacted adsorbing/desorbing material layer, each disk having a opening there through;
a conduit positioned within a length of the interior space of the cartridge and adapted for receiving the plurality of nestable disks through each opening; and,
wherein the plurality of nestable disks are inserted into the cartridge onto the conduit in alternating layers of the heat conductive material and the adsorbing/desorbing material so that the heat transfer material is in contact with the sidewalls of the cartridge.

11. The assembly of claim 10, wherein the conduit further comprises a plurality of openings along its length for permitting the flow of ammonia gas to charge or recharge the adsorbing/desorbing material.

12. The assembly of claim 10, wherein the conduit further includes an expandable outer diameter for fracturing the plurality of nestable disks.

13. A method for reductant storage wherein the reductant is ammonia, the method comprising the steps of:
providing a cartridge having sidewalls;
providing a plurality of nestable disks comprising a heat conductive material forming a cup for receiving an ammonia adsorbing/desorbing material layer, each disk having a opening there through;
positioning a conduit having an outer diameter within a length of the interior space of the cartridge;
stacking the plurality of disks onto the conduit in alternating layers of heat conductive material and ammonia adsorbing/desorbing material;
expanding the outer diameter of the conduit within the plurality of disks fracturing the ammonia adsorbing/desorbing material;
contacting the ammonia adsorbing/desorbing material and heat conductive layer with the sidewalls of the cartridge;
applying heat from a heat source to the cartridge, the fractured ammonia adsorbing/desorbing material, and the heat conductive layer; and
releasing ammonia from the ammonia adsorbing/desorbing material into an exhaust system for use in the reduction of NOₓ.

14. The method of claim 13, wherein the method further comprises the step of initially charging the ammonia adsorbing/desorbing material with ammonia gas after loading the disks onto the conduit and in the cartridge.

15. The method of claim 13, wherein the method further comprises the step of recharging the ammonia adsorbing/desorbing material with ammonia gas.
